(19) United States
(12) Patent Application Publication
(10) Pub. No.: US 2007/0288713 A1
(43) Pub. Date: Dec. 13, 2007

(54) Data Recording/Reproducing Device and Method

(76) Inventors: Hiroshi Sugimoto, Osaka (JP); Shinji Sasaki, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/659,661

(22) PCT Filed: Aug. 25, 2005
(86) PCT No.: PCT/JP05/15468

§ 371 Date: Feb. 7, 2007

(30) Foreign Application Priority Data
Aug. 26, 2004 (JP) 2004-246128

(51) Int. Cl. G06F 12/16

(52) U.S. Cl. 711/162

(57) ABSTRACT

Provided is a data recording/reproducing device and a method thereof, by which copy protection can be realized privately by an easy method using the established conventional unauthorized copy prevention functions.

A data recording/reproducing device (100) (a) receives a pass-code corresponding to a user, (b) protect content data to be reproduced only by the user, and records the protected content data into a storage medium, using the pass-code which is obtained to record the content data, and (c) reproduces the content data, which has been protected to be reproduced only by the user and recorded in the storage medium, using the pass-code which is obtained to reproduce the content data.

### TECHNICAL FIELD

The present invention relates to a data recording/reproducing device which records and reproduces audio/video content data, and more particularly to a data recording/reproducing device which can protect the content data not to be reproduced by anyone except a user, then record and reproduce the protected content data.

### BACKGROUND ART

Conventionally, a data recording/reproducing device holds predetermined ID bits for unauthorized-copy prevention (forbidden codes according to Copy Generation Management System (CGMS) standard), and controls copy using the ID bits (Patent Reference 1, for example).

In addition, regarding data which is copied without authorization, in order to prevent such copied data from being effectively reproduced, the data is previously encrypted and then recorded (Patent Reference 2, for example).

[Patent Reference 1] Japanese Patent Application Laid-Open No. 2001-16542

[Patent Reference 2] Japanese Patent Application Laid-Open No. 11-39795

### DISCLOSURE OF INVENTION

### Problems that Invention is to Solve

With wide use of data recording/reproducing devices and full-scale start of digital broadcasting, in order to protect rights of content providers distributing contents, it is indispensable for the data recording/reproducing devices to encrypt and record data to prevent second use, unauthorized re-distribution, and duplicating of the data. However, such encrypted and recorded data is permitted to be reproduced by legitimate devices, so that it is impossible to conceal the content data personally.

Thus, in view of the above problem, an object of the present invention is to provide a data recording/reproducing device and a method thereof, by which the personal copy protection can be realized by an easy method using the conventional unauthorized copy prevention functions.

### Means to Solve the Problem

In order to achieve the above object, (a) a data recording/reproducing device according to the present invention records and reproduces content data, and includes: (a1) a pass-code obtaining unit which obtains a pass-code corresponding to a user; (a2) a recording unit which protects the content data to be reproduced only by the user, and record the protected content data into a storage medium, using the pass-code which is obtained to record the content data; (a3) and a reproducing unit which reproduces the protected and recorded content data, using the pass-code which is obtained to reproduce the content data.

Thereby, it is possible for each user to record, into a storage medium, content data which is protected to be reproduced only by the user. Moreover, the content data, which is protected to be reproduced only by the user and is recorded in the storage medium, is not able to be reproduced without the pass-code. Thus, who can reproduce the content data is restricted to the user.

Further, (b) when the pass-code is associated with individual identification information for identifying the user, and managed by a data management device, the data recording/reproducing device further comprising (b1) an individual identification information obtaining unit which obtains the individual identification information regarding the user, (b2) wherein the pass-code obtaining unit: sends the individual identification information obtained by the individual identification information obtaining unit to the data management device; and receives the pass-code associated with the sent individual identification information from the data management device.

Thereby, it is possible to prevent the content data from being reproduced by anyone except the user who records the content data. Conventionally, if a certain subscriber records content data broadcasted by a broadcast station or content data created by a content producer, anyone can reproduce the recorded content data. However, according to the present invention, the recorded content data is reproduced only by the subscriber who has recorded the content data. As a result, it is possible to provide the broadcast station and the content producer with a means for gaining an adequate profit from the content data.

Still further, (c) the individual identification information obtained by the individual identification information obtaining unit is one of: (c1) identification information for specifying the user, which is obtained by inquiring the user; (c2) and identification information allocated to an IC card issued to the user, which is obtained by referring to the IC card.

Thereby, it is possible to authenticate the user easily. Then, it is possible to prevent the content data from being reproduced by anyone except the user. More specifically, the content data cannot be reproduced without user′ setting of the pass-code, nor without the IC card possessed by the user.

Alternatively, (d) the pass-code is able to be updated to a new pass-code, the data recording/reproducing device further comprising: (d1) a storage unit, in which the pass code is stored being associated with individual identification information for identifying the user and medium identification information allocated to the storage medium; (d2) an individual identification information obtaining unit which obtains the individual identification information regarding the user; (d3) a specifying unit which specifies the pass-code to be updated, from one or more pass-code stored in the storage unit, based on the individual identification information obtained by the individual identification information obtaining unit and the medium identification information of the storage medium; and (d4) a pass-code updating unit which updates the specified pass-code to a new pass-code which is newly obtained by the pass-code obtaining unit.

Thereby, who can update the pass-code can be restricted to the user.

Still further, (e) the individual identification information obtained by the individual identification information obtaining unit is one of: (e1) identification information for specifying the user, which is obtained by inquiring the user; (e2) and identification information allocated to an IC card issued to the user, which is obtained by referring to the IC card.

Thereby, it is possible to authenticate the user easily. Then, it is possible to prevent the pass-code from being updated by anyone except the user. More specifically, the pass-code cannot be updated without user′ setting of the individual identification information, or without the IC card possessed by the user.

Alternatively, (f) the pass-code obtained by the pass-code obtaining unit is one of: (f1) a code set by the user, which is obtained by inquiring the user; (f2) and a code which is generated as a random number, using, as a random seed, identification information allocated to an IC card issued to the user.

Thereby, it is possible to obtain the pass-code easily.

Alternatively, (g) a key used to encrypt the content data is an encryption key, a key used to decrypt the content data is a decryption key, and a key used to generate the decryption key using the pass-code is a seed key, and (g1) the recording unit includes: (g1-1) a first key generating unit which generates one of the encryption key and the seed key, using the pass-code; (g1-2) a content data encrypting unit which encrypts the content data using the encryption key; and (g1-3) a writing unit which writes the encrypted content data and the seed key into the storage medium, the encrypted content data and the seed key being associated with each other, and (g2) the reproducing unit includes: (g2-1) a reading unit which reads the encrypted content data and the seed key from the storage medium; (g2-2) a second key generating unit which generates the decryption key using the pass-code and the seed key; and (g2-3) an encrypted content data decrypting unit which decrypts the encrypted content data using the decryption key.

Thereby, the decryption key cannot be generated without the pass-code, even if the seed key recorded in the storage medium is used. Then, the content data, which is encrypted using the encryption key, is not able to be decrypted. In other words, using the pass-code, the content data is protected to be reproduced only by the user.

Further, (h) the first key generating unit includes: (h1) a medium unique key generating unit which generates a key unique to the storage medium, using medium identification information allocated to the storage medium; (h1-1) a first temporary key generating unit which generates a temporary key, using a time and the key unique to the storage medium; (h1-2) an encryption key generating unit which generates the encryption key, using the temporary key and the pass-code; and (h1-3) a seed key generating unit which generates the seed key by encrypting the temporary key, and (h2) the second key generating unit includes: (h2-1) a second temporary key generating unit which generates the temporary key, by decrypting the seed key; and (h2-2) a decryption key generation unit which generates the decryption key, using the temporary key and the pass-code.

Thereby, even if the seed key recorded in the storage medium is used, the decryption key cannot be generated without the pass-code, thereby failing to decrypt the content data. This means that it is possible to prevent the content data from being reproduced by anyone except the user. In addition, using the pass-code, the content data can be protected to be reproduced only by the user.

Further, (i) when the pass-code is able to be updated to a new pass-code, (i1) the encryption key generating unit generates a new encryption key, using the new pass-code and the temporary key generated by the first temporary key generation unit, (i2) the content data encryption unit re-encrypts the content data using the new encryption key, the content data and decrypted by the decrypted content data decryption unit, and (i3) the writing unit re-writes the encrypted content data recorded in the storage medium to the newly encrypted content data.

Thereby, even if the pass-code is lost or damaged, the encrypted content data can be reproduced again using the new pass-code. Thus, it is possible to prevent the content data, which is protected to be reproduced only by the user and recorded, from being unable to be reproduced by the user, due to a loss or a damage of the pass-code.

Alternatively, (j) (j1) the first key generating unit includes: (j1-1) a medium unique key generating unit which generates a key unique to the storage medium, using medium identification information allocated to the storage medium; (j1-2) a first temporary key generating unit which generates a temporary key, using the encryption key and the key unique to the storage medium and; and (j1-3) a seed key generating unit which generates a seed key, using the pass-code and the temporary key, and (j2) the second key generating unit includes: (j2-1) a second temporary key generating unit which generates the temporal key, using the pass-code and the seed key; and (j2-2) a decryption key generating unit which generates the decryption key, using the temporary key and the key unique to the storage medium.

Thereby, even if the seed key recorded in the storage medium is used, the decryption key cannot be generated without the pass-code, thereby failing to decrypt the content data. In other words, it is possible to prevent the content data from being reproduced by anyone except the user. In addition, using the pass-code, the content data can be protected to be reproduced only by the user.

Still further, (k) the pass-code is able to be updated to a new pass-code, (k1) the seed key generating unit generates a new seed key, using the new pass-code and the temporary key generated by the second temporary key generation unit, (k2) the writing unit re-writes the seed key recorded in the storage medium to the new seed key.

Thereby, even if the pass-code is lost or damaged, the seed key can be generated again using the new pass-code. Thus, it is possible to prevent the content data, which is protected to be reproduced only by the user and recorded, from being unable to be reproduced by the user, due to a loss or a damage of the pass-code.

Here, a data management device (l) manages a pass-code corresponding to a user, and includes: (l1) a storage unit, in which the pass-code is stored in association with individual identification information for identifying the user; (l2) a receiving unit which receives the individual identification information from a data recording/reproducing device which records and reproduces content data; (l3) a specifying unit which specifies the pass-code associated with the individual identification information received by the receiving unit, among one or more pass-code stored in the storage unit; and (l4) a sending unit which sends the pass-code specified by the specifying unit to the data recording/reproducing device.

Further, (m) when there is no pass-code associated with the individual identification information received by the receiving unit, among one or more pass-code stored in the storage unit, (m1) the specifying unit generates a pass-code; and (m2) in the storage unit, the pass-code generated by the specifying unit is associated with the individual identification information received by the receiving unit.

Conventionally, if a certain subscriber records content data broadcasted by a broadcast station or content data created by a content producer, anyone can reproduce the recorded content data. However, the prevent invention can provide the broadcast station and the content producer with a means for gaining an adequate profit from the content data.

Note that the present invention can be realized not only as the data recording/reproducing device, but also as a data recording/reproducing system having the data recording/reproducing device and a data management device which are connected with each other via a data communication network.

Further, the present invention can be realized as: a data recording/reproducing method for controlling the data recording/reproducing device; a data recording/reproducing program for causing a computer system or the like to execute the data recording/reproducing method; or a storage medium in which the data recording/reproducing program is stored.

Still further, the present invention can be realized as: a data recording device having functions related to the recording functions of the data recording/reproducing device; a data recording method performed by the data recording device; a data recording program causing a computer system or the like to execute the data recording method; or a storage medium in which the data recording program is stored.

Still further, the present invention can be realized as: a data reproducing device having functions related to the reproducing functions of the data recording/reproducing device; a data reproducing method performed by the data reproducing device; a data reproducing program causing a computer system or the like to execute the data reproducing method; or a storage medium in which the data reproducing program is stored.

### EFFECTS OF THE INVENTION

According to the present invention, it is possible to easily protect content data privately not to be reproduced by anyone except a user, using the conventional unauthorized copy prevention function.

Further, a pass code used to privately protect and encrypt the content data is not stored in the storage medium, so that the encrypted content cannot be decrypted by analyzing the medium.

Furthermore, even if information regarding an encryption key used for the content protection is forgotten, the protection processing can be performed again using new information.

### BRIEF DESCRIPTION OF DRAWINGS

FIG. 1 is a block diagram showing a data recording/reproducing device according to the first embodiment of the present invention.

FIG. 2 is a diagram showing a data structure according to the first embodiment of the present invention.

FIG. 3 is a flowchart showing encrypted title key generating processing according to the first embodiment of the present invention.

FIG. 4 is a flowchart showing recording processing according to the first embodiment of the present invention.

FIG. 5 is a flowchart showing reproducing processing according to the first embodiment of the present invention.

FIG. 6 is a flowchart showing encryption key updating processing according to first embodiment of the present invention.

FIG. 7 is a diagram showing a data structure of individual information according to the first embodiment of the present invention.

FIG. 8 is a diagram showing a situation where the data recording/reproducing device is connected to an external monitor, according to the first embodiment of the present invention.

FIG. 9 is a diagram explaining a user interface according to the first embodiment of the present invention.

FIG. 10 is a schematic diagram showing the data recording/reproducing device according to the first embodiment of the present invention.

FIG. 11 is another schematic diagram showing the data recording/reproducing device according to the first embodiment of the present invention.

FIG. 12 is a block diagram showing the data recording/reproducing device according to the second embodiment of the present invention.

FIG. 13 is a flowchart showing title key generating processing according to the second embodiment of the present invention.

FIG. 14 is a block diagram showing a data recording/reproducing system according to the third embodiment of the present invention.

FIG. 15 is a diagram showing a data structure of individual information according to the third embodiment of the present invention.

FIG. 16 is a flowchart showing pass-code receiving processing according to the third embodiment of the present invention.

### NUMERICAL REFERENCES

100, 1000 data recording/reproducing device
101, 1001, 1207 data input unit
102, 1002, 1208 temporary storage unit
103, 1003, 1209 encryption unit
104, 1004, 1210 read/write unit
105, 1005, 1211 decryption unit
106, 1006, 1212 data output unit
107, 1007, 1213 storage medium
108 individual identifying unit
109, 1008, 1203 individual information storage unit
110, 1009, 1202, 1215 key processing unit
1010, 1216 card reading unit
1011, 1217 IC card
1200 data recording/reproducing system
1204 server system
1205 Internet
1206 client system
1201, 1214 communication unit

### BEST MODE FOR CARRYING OUT THE INVENTION

### First Embodiment

The following describes the first embodiment according to the prevent invention with reference to the drawings.

A data recording/reproducing device according to the first embodiment of the present invention (a) records and reproduces content data. The data recording/reproducing device (a1) obtains a pass-code corresponding to a user; (a2) protects the content data to be reproduced only by the user, and records the protected content data into a storage medium, using the pass-code which is obtained to record the content data; and (a3) reproduces the protected and recorded content data, using the pass-code which is obtained to reproduce the content data.

More specifically, (b) a key used to encrypt the content data is an encryption key, a key used to decrypt the content data is a decryption key, and a key used to generate the decryption key using the pass-code is a seed key, and (b1) when the content data is recorded: (b1-1) one of the encryption key and the seed key is generated using the pass-code; (b1-2) the content data is encrypted using the encryption key; and (b1-3) the encrypted content data and the seed key are written into the storage medium, the encrypted content data and the seed key being associated with each other, and (b2) the content data is reproduced: (b2-1) the encrypted content data and the seed key are read from the storage medium; (b2-2) the decryption key is generated using the pass-code and the seed key; and (b2-3) the encrypted content data is decrypted using the decryption key.

Based on the above, the following describes the data recording/reproducing device according to the first embodiment of the present invention.

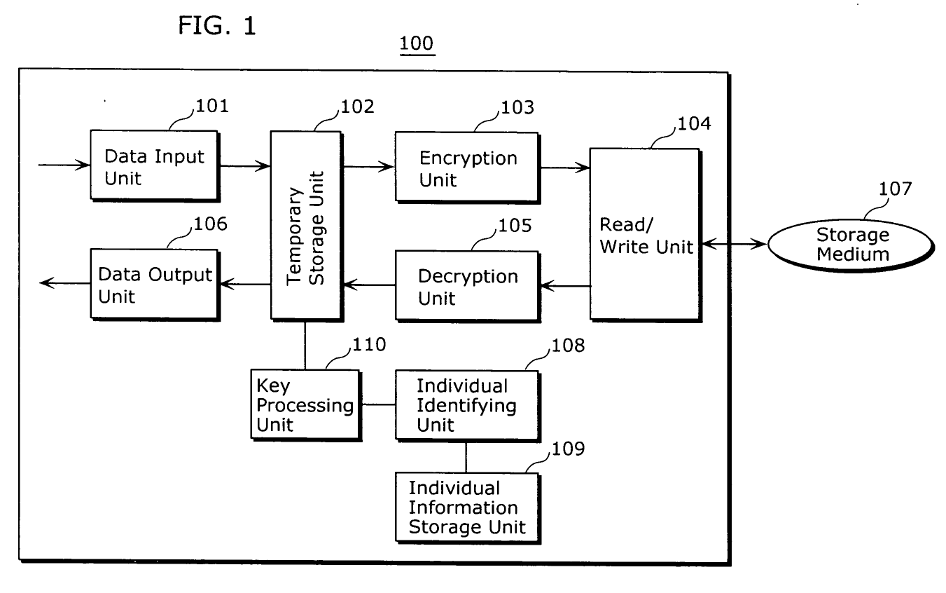

Firstly, FIG. 1 is a block diagram of the data recording/reproducing device according to the first embodiment of the present invention. As shown in FIG. 1, the data recording/reproducing device 100 includes a data input unit 101, a temporary storage unit 102, an encryption unit 103, a read/write unit 104, a decryption unit 105, a data output unit 106, a storage medium 107, an individual identifying unit 108, an individual information storage unit 109, and a key processing unit 110.

The data input unit 101 converts signals inputted from the outside, into data in a digital format. In addition, the data input unit 101 analyzes the converted data. For example, when the converted data conforms to a digital broadcasting standard, the data input unit 101 analyzes detail of the converted data based on the digital broadcasting standard. From the converted data, the data input unit 101 extracts only program data of a desired channel, or extracts copy control information aimed at copyright protection, for example. Then, the extracted program data, copy control information, and the like are accumulated into the temporary storage unit 102.

The temporary storage unit 102 is a high-speed memory represented by a SDRAM, and used as a buffer among various processing units having different transfer speeds.

The data output unit 106 outputs the content data accumulated in the temporary storage unit 102. Here, in order to output the content data, the data output unit 106 adds the content data with information by which processing for the content data by external devices can be controlled.

The read/write unit 104 reads data from and writes data into the portable storage medium 107 such as a DVD-RAM and a Blue-ray disk. More specifically, when the content data is to be recorded, the read/write unit 104 writes, into the storage medium 107, the encrypted content data and an encrypted title key Kte associated with the encrypted content data. Further, when the content data is to be reproduced, the read/write unit 104 reads out, from the storage medium 107, the encrypted content data and the encrypted title key Kte associated with the encrypted content data. In order to update a pass-code used in the private protection, the encrypted content data and the associated encrypted title key Kte are read out from the storage medium 107, and the read out content data is re-written as newly encrypted content data into the storage medium 107.

Among various data accumulated in the temporary storage unit 102, the encryption unit 103 selects data to be recorded into the storage medium 107, and encrypts the selected data. Then, the encrypted data after the encryption is written into the storage medium 107 by the read/write unit 104. More specifically, if a user wishes to privately protect and record content data not to be reproduced by anyone except the user, a private title key Kp is used to encrypt the content data to generate encrypted content data. On the other hand, if the content data does not need the private protection, a title key Kt is used to encrypt the content data to generate encrypted content data.

The decryption unit 105 decrypts the encrypted data which the read/write unit 104 reads out from various data recorded in the storage medium 107. Then, the decrypted data is accumulated into the temporary storage unit 102. More specifically, if the user has privately protected and recorded the content data, the private title key Kp is used to decrypt the encrypted content data to generate decrypted content data. On the other hand, if the content data has been recorded without the private protection, the title key Kt is used to decrypt the encrypted content data to generate decrypted content data.

The individual identifying unit 108 identifies the user who, for example, has inputted a password for the private protection. In addition, the individual identifying unit 108 receives a parameter inputted by the identified user. The parameter is a pass-code necessary to generate a key for the private protection. The inputted pass-code is stored in the individual information storage unit 109, in case the user will forget the pass-code. More specifically, when the content data is to be recorded or reproduced, the individual identifying unit 108 obtains the pass-code corresponding to the user. Here, the individual identifying unit 108 inquiries the user about individual identification information for identifying the user.

Note that, if the individual identifying unit 108 has a function of updating the pass-code, the individual identifying unit 108 may: obtain the individual identification information for identifying the user; identify a target pass-code to be updated, among one or more pass-codes stored in the individual information storage unit 109, based on the obtained individual identification information and a medium ID of a storage medium; and update the target pass-code stored in the individual information storage unit 109, to be a new pass-code. In the following explanation, the individual identifying unit 108 is assumed to have the function of updating pass-codes, but such a function is not always required. This means that the function of updating pass-codes can, of course, be eliminated from the individual identifying unit 108.

Here, the individual information storage unit 109 is assumed to be a nonvolatile memory represented by an Electronically Erasable and Programmable Read Only Memory (EEPROM).

The key processing unit 110 generates keys which are used to record and reproduce content data. More specifically, when (a) content data is to be recorded, (a1) a medium unique key Km is generated using a medium ID assigned to a storage medium in which the content data is to be recorded, (a2) a title key Kt is generated using the medium unique key Km and a time t and (a3) an encrypted title key Kte is generated by encrypting the title key Kt. Further, when (a4) the content data is to be privately protected, a private title key Kt is generated using a pass-code Np and the title key Kt. Furthermore, when (b) the decrypted content data is to be reproduced, the title key Kt is obtained by decrypting the encrypted title key Kte. Note that, when (c) a pass-code is to be updated, (c1) the title key Kt is obtained by decrypting the encrypted title key Kte which has been read out from the storage medium, (c2) the private title key Kp1 is generated using the title key Kt and the pass-code Np1 which is to be updated and, and (c3) a new private title key Kp2 is generated using the title key Kt and a new pass-code Np2.

By the data recording/reproducing device 100 having the above structure, the following recording and reproducing processing are performed.

In the recording processing, the data recording/reproducing device 100 is operated as described below. The data input unit 101 receives digital broadcast waves, then converts the received digital broadcast waves into data in a digital format, then extracts desired program data (content data) referring to a program number assigned to the converted data, and transfers the extracted program data into the temporary storage unit 102 for the following processing. Here, copy generation management information as described below is also extracted.

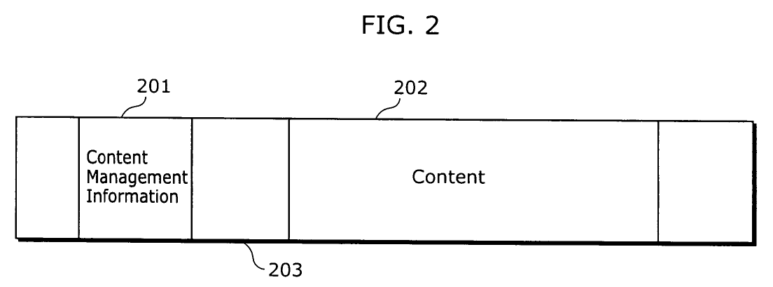

The content data accumulated in the temporary storage unit 102 is written into the storage medium 107 by the read/write unit 104. As shown in FIG. 2, when the content data is written, into an area 203 of the storage medium are recorded: a content file 202; and content management information 201 which is information accompanying the data, such as the copy control information and encryption key information.

If the copy generation management information included in the content data indicates that the content data is prohibited to be copied (copy-never), the recording processing is stopped. When the copy generation management information indicates that the content data is permitted to be copied only for one generation (copy-one-generation), information for prohibiting further copying is set as the copy control information of the content management information 201, and then the content data is encrypted and recorded. Further, even if the content data is to be privately protected regardless of the copy control information, the content data is encrypted and recorded. When the copy generation management information indicates that the content data is permitted to be copied freely (copy-free) and the content data does not need to be privately protected, the information of copy-free is set as the copy control information of the content management information 201, and the content data is not encrypted but recorded it is.

In other words, when the user wishes to protect and record the content data, the data recording/reproducing device 100 (a) obtains a pass-code corresponding to the user. Here, the pass-code has been set by the user, and the data recording/reproducing device 100 inquiries the user about the pass-code thereby obtaining the pass-code. Next, (b) a private title key Kp is generated using the obtained pass-code and the title key Kt, and (c) encrypted content data is generated by encrypting the content data using the generated private title key Kp. Then, (d) an encrypted title key Kte is generated by encrypting the title key Kt, and (e) the generated encrypted content data and the generated encrypted title key Kte are written into the storage medium.

In the reproducing processing, the data recording/reproducing device 100 is operated as described below. The recorded content data is read out from the storage medium 107 by the read/write unit 104. Here, if the content data has been encrypted, the decryption unit 105 decrypts the content data. The data output unit 106 adds the content data with copy control information and outputs the content data.

The title key used in the encryption performed by the encryption unit 103 is generated further using the medium unique key and a time varying factor of the storage medium 107. Here, if the content data is to be privately protected, the key is generated still further using the pass-code which the user inputs. Here, the private title key aimed at private protection is not recorded in the storage medium 107, in order to preventing the private title key from being used by other users. Instead, the user inputs the pass-code also in the reproducing processing, in order to generate the private title key.

This means that, when the content data which the user privately protects and records is to be reproduced, the data recording/reproducing device 100 (a) obtains a pass-code corresponding to the user. Here, the pass-code has been set by the user, and the data recording/reproducing device 100 inquiries the user about the pass-code thereby obtaining the pass-code. Moreover, (b) the encrypted content data and the encrypted title key Kte are read out from the storage medium, and (c) the title key Kt is obtained by decrypting the read-out encrypted title key Kte. Then, (d) a private title key Kp is generated using the obtained pass-code and the generated title key Kt, and (e) the content data is the obtained by decrypting the read-out encrypted content data using the generated private title key Kp.

Next, a data structure of the individual information stored in the individual information storage unit 109 is described.

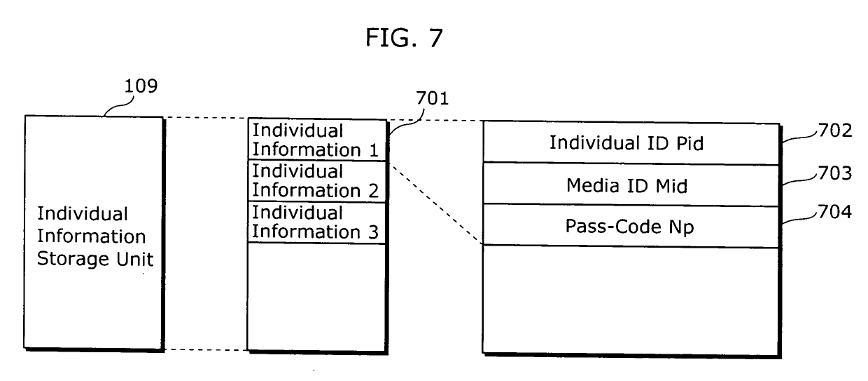

FIG. 7 is a diagram showing an example of a data format of the individual information. As shown in FIG. 7, individual information 701 is held on a user-by-user basis. The individual information 701 includes an individual ID 702, a medium ID 703, and a pass-code Np 704. The individual ID 702 is used to identify a user. The medium ID 703 is used to identify a storage medium. The pass-code Np 704 is a parameter inputted by the user to protect the content data privately. Based on the individual ID 702 and the medium ID 703, the individual identifying unit 108 determines whether or not the user can privately protect the content data in a target storage medium.

As described above, in the first embodiment of the present invention, the private title key is used to encrypt the content data when the content data is to be privately protected and recorded, and also to decrypt the encrypted content data when the privately protected and recorded content data is to be reproduced. Here, in order to generate such a private title key, a pass-code inputted by the user is indispensable. This pass-code makes it possible to provide circumstances where only a user, who has set the pass-code when recording content data, can reproduce the content data. In addition, in order to hold information for associating the user with the storage medium, it is possible to re-encrypt the encrypted content data using a new pass-code, even if the user forgets the pass-code which has been set in generating of the private title key Kp.

Note that the data input unit 101 may have a function of digitalizing and compressing analog image data inputted from the outside.

Note also that the data input unit 101 may have a function of imaging.

Note also that the data output unit 106 may have a function of converting the digitalized and compressed image data into analog image data, and transferring the analog image data to an output device such as a television monitor.

Note also that the individual identifying unit 108 may have a function of identifying an individual using body information unique to a body of the individual, such as voice, fingerprint, and retina. Here, the body information is assumed to be previously stored in the data recording/reproducing device 100.

Note also that the individual identifying unit 108 may have a function of identifying a pass-code using an ID unique to a system device. Note also that the storage medium 107 may have a function by which content data can be reproduced only by a storage medium in which the content data is recorded.

Note also that, in order to prevent from tampering of the copy control information in the content management information 201, the encryption unit 103 may have a function of encrypting the content management information 201 together with the content data together.

Note also that the read/write unit 104 may have a reading and writing function represented by Integrated Drive Electronics (IDE) or Small Computer System Interface (SCSI). Further, the read/write unit 104 may be an external device having a function of exchanging the copy control information between the read/write unit 104 and the temporary storage unit 102 by a high-security method.

Note also that each of the encryption unit 103 and the decryption unit 105 may have a function of detecting video watermarks embedded in content data.

Note also that the first embodiment has described the recording of video data. However, the present invention can be applied to recording of audio data, or network distribution of streaming data or program data.

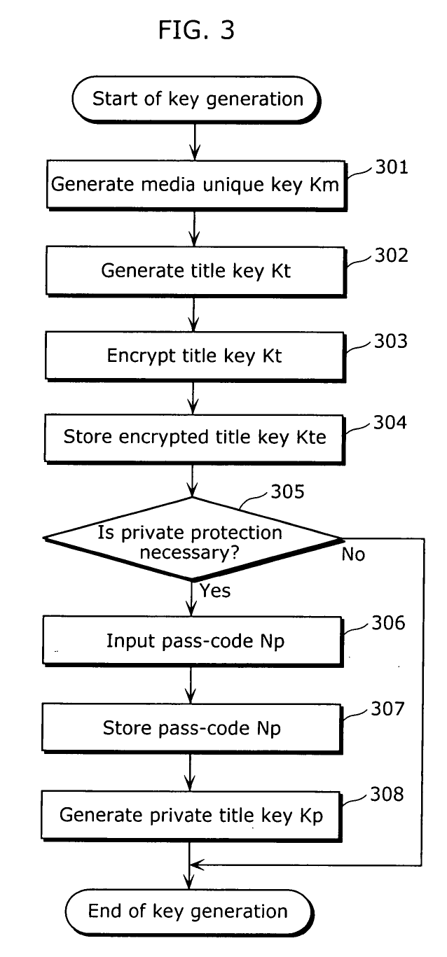

FIG. 3 is a flowchart showing title key generating processing according to the first embodiment of the present invention. The processing is described with reference to FIGS. 1, 3, and 7.

The data recording/reproducing device 100 generates a medium unique key Km (Km=F(Mid)), using a medium ID 703 which is information unique to a specific storage medium 107 and read out from the storage medium 107 (Step 301). Here, Mid is a medium ID represented by a serial number. Next, the medium unique key Km is added with a time varying factor to generate a title key Kt (Kt=G(Km, t)) (Step 302). The title key Kt is important data for decrypting content data to be recorded. In order to prevent tampering of the generated title key Kt, the data recording/reproducing device 100 encrypts the title key Kt to be recorded into the storage medium 107 (Step 303). Then, the encrypted title key Kte (Kte=E(Kt)) is recorded into the storage medium 107 (Step 304). In general encrypting and recording of content data, the encrypting is performed using this title key Kt. It is determined whether or not the content data is to be privately protected (Step 305). If the private protection is necessary, a private title key Kp is to be generated. Therefore, the user is requested to input a pass-code Np 704 necessary to generate the private title key Kp (Step 306). Then, as individual information 701, into the individual information storage unit 109 stored are: an individual ID 702 for identifying the user who has inputted the pass-code Np704; the medium ID 703 for identifying the storage medium 107; and the inputted pass-code Np704 (Step 307). A private title key Kp (Kp=H(Kt, Np)) for the private protection is generated (Step 308).

As described above, instead of storing the generated private title key in the storage medium, the data recording/reproducing device 100 generates the private title key every time the content data is to be reproduced. If the content data is privately protected, only the user, who has inputted the pass-code, can decrypt the encrypted content data.

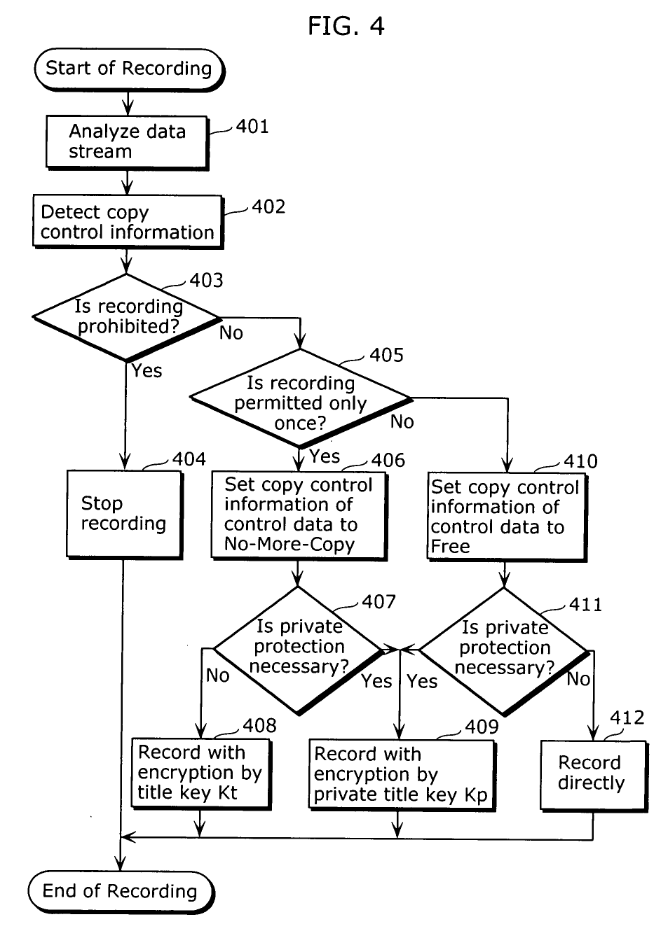

FIG. 4 is a flowchart showing video recording processing according to the present invention. Here, as one example, the data recording/reproducing device 100 is assumed to control the data input unit 101, the temporary storage unit 102, the encryption unit 103, the read/write control unit 104, the individual identifying unit 108, the individual information storage unit 109, and the key processing unit 110, in order to record digital broadcast waves.

As shown in FIG. 4, the data recording/reproducing device 100 analyzes a data stream inputted into the data input unit 101, and extracts a program to be recorded (Step 401). From content data in the extracted program, copy generation management information is obtained (Step 402). Further, the content data in the extracted program is transferred to the temporary storage unit 102. Then, based on the obtained copy generation management information, it is examined whether or not the content data is prohibited to be copied, in other words, whether or not the content data is prohibited to be recorded into the data recording/reproducing device 100 (Step 403). Here, if the content data is prohibited to be recorded (Yes at Step 403), then the recording processing is terminated (Step 404). On the other hand, if the content data is not prohibited to be recorded (No at Step 403), then it is further examined whether or not the content data is permitted to be copied only for one generation, in other words, whether or not the number of recording times of the content data is one generation only (Step 405).

As a result of the examination, if the content data is permitted to be recorded for one generation only (Yes at Step 405), then the data recording/reproducing device 100 sets information for prohibiting further recording (no more copy) as the copy control information in the content management information 201 (Step 406). Next, it is determined whether or not private protection is necessary for the content data (Step 407). If the private protection is not necessary (No at Step 407), then, in order to prevent the content data from being copied without authorization, the content data is encrypted using the title key Kt and recorded into the storage medium 107 (Step 408). If the private protection is necessary (Yes at Step 407), the content data is encrypted using the private title key Kp and recorded into the storage medium 107 (Step 409).

On the other hand, if there is no limitation of copying of the content data to be recorded, then the data recording/reproducing device 100 sets information for permitting to copy the content data freely (copy free) as the copy control information in the content management information 201 (Step 410). Then, it is further determined whether or not private protection is necessary for the content data (Step 411). If the private protection is necessary (Yes at Step 411), then the content data is encrypted using the private title key Kp and recorded into the storage medium 107 (Step 409). If the private protection is not necessary (No at Step 411), then the content data is not encrypted to be recorded into the storage medium 107 (Step 412).

As described above, in the recording processing, the data recording/reproducing device 100 does not record content data if the copy generation management information includes in the content data prohibits the recording, and encrypts and records content data based on the copy control information included in the content data, so that the data recording/reproducing device 100 can realize copyright protection which is not against intention of a producer of the content data. Moreover, the content data is encrypted using a private title key based on information which only the user knows, so that the data recording/reproducing device 100 enables the user to privately protect the content data.

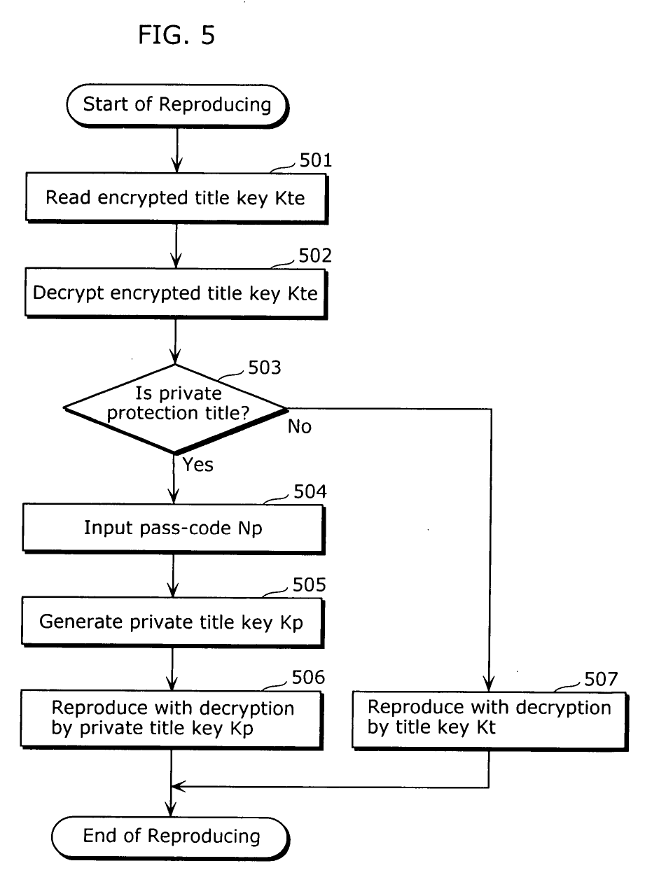

FIG. 5 is a flowchart showing video reproducing processing according to the present invention. Here, as one example, the data recording/reproducing device 100 is assumed to control the temporary storage unit 102, the read/write control unit 104, the decryption unit 105, the data output unit 106, the individual identifying unit 108, the individual information storage unit 109, and the key processing unit 110, in order to reproduce the recorded digital broadcast waves.

The data recording/reproducing device 100 reads out the encrypted title key Kte recorded in the storage medium 107 (Step 501). Then, the encrypted title key Kte is decrypted to be the title key Kt (Kt=D(Kte)) necessary to decrypt the encrypted content data (Step 502). Next, it is determined whether or not the content data to be reproduced is privately protected (Step 503). If the content data is privately protected (Yes at Step 503), then the user is requested to input a pass-code Np (Step 504). Then, using the pass-code Np inputted by the user, a private title key Kp which is a true title key to decrypt the content data is generated (Step 505). Using the private title key Kp, the content data is decrypted (Step 506). On the other hand, if the content data is not privately protected (No at Step 503), then the content data is decrypted using the title key Kt (Step 507). Then, the content data which is decrypted in the temporary storage unit 102 is outputted by the data output unit 106 to be reproduced.

As described above, when the content data is reproduced, only the user can make the true title key by inputting the specific pass-code, so that it is possible to realize the private protection effectively.

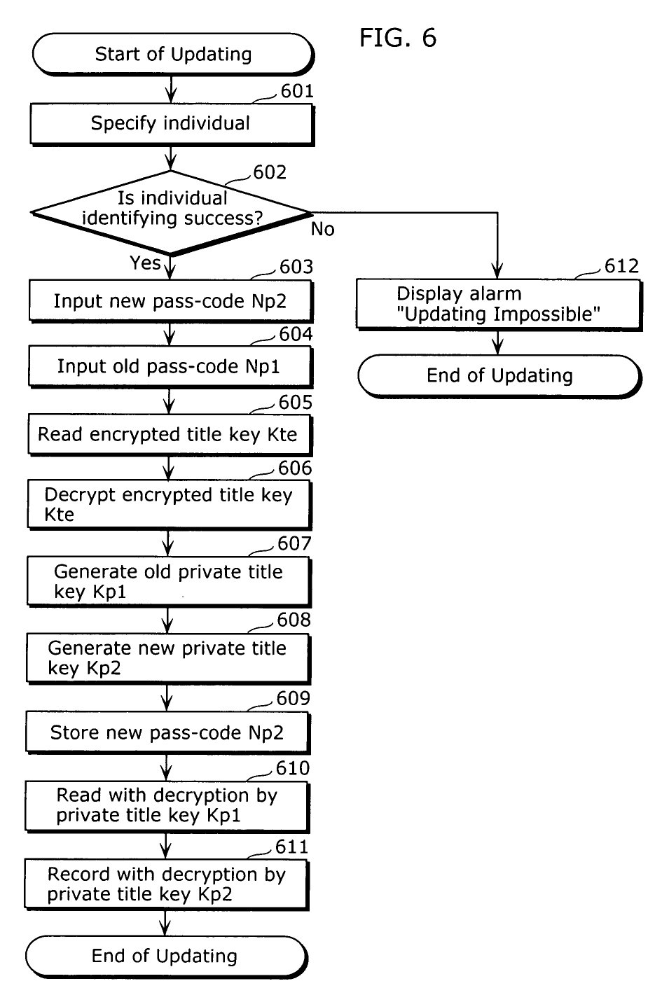

FIG. 6 is a flowchart showing processing for updating the private protection according to the present invention. Here, as one example, it is assumed that, when the user, who has set previously a pass-code, forgets the pass-code, the data recording/reproducing device 100 controls the temporary storage unit 102, the encryption unit 103, the read/write unit 104, the decryption unit 105, the individual identifying unit 108, the individual information storage unit 109, and the key processing unit 110, in order to re-protect the content data using a new pass-code.

The data recording/reproducing device 100 specifies an user (Step 601). By searching for: individual information regarding the specified user; and medium information regarding a storage medium 107 set in the data recording/reproducing device 100, it is determined whether or not the individual information storage unit 109 has the individual information corresponding to the specified user (Step 602). If the individual information storage unit 109 has the individual information for identified the user (Yes at Step 602), then the user is requested to input a new pass-code Np2 (Step 603). Then, the earlier pass-code Np1 which the user has forgotten is read out from the individual information storage unit 109 (Step 604). Next, the encrypted title key Kte is read out from the storage medium 107 (Step 605). Then, the read-out encrypted title key Kte is decrypted (Step 606). Using the earlier pass-code Np1 and the decrypted title key Kt, the earlier private title key Kp1 is generated (Step 607). Using the new pass-code Np2 inputted by the user and the decrypted title key Kt, a new private title key Kp2 is generated (Step 608). Since the new private title key Kp2 is generated, the individual information is updated using the new pass-code Np2 (Step 609). Using the earlier private title key Kp1 generated by the earlier forgotten pass-code Np1, the encrypted content data is decrypted (Step 610). Using the newly generated private title key Kp2, the decrypted content data is encrypted again and recorded (Step 611). On the other hand, if it is determined, by searching for a relationship between the individual identification of the user and the storage medium information, that the user is not related to the storage medium, then the user is notified that the content data cannot be protected again using a new key, and the processing is terminated.

As described above, even if the user forgets the already set pass-code, it is possible to protect the content data again using a newly set pass-code if the user can be identified.

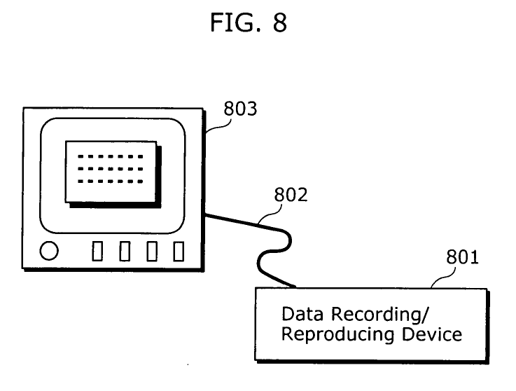

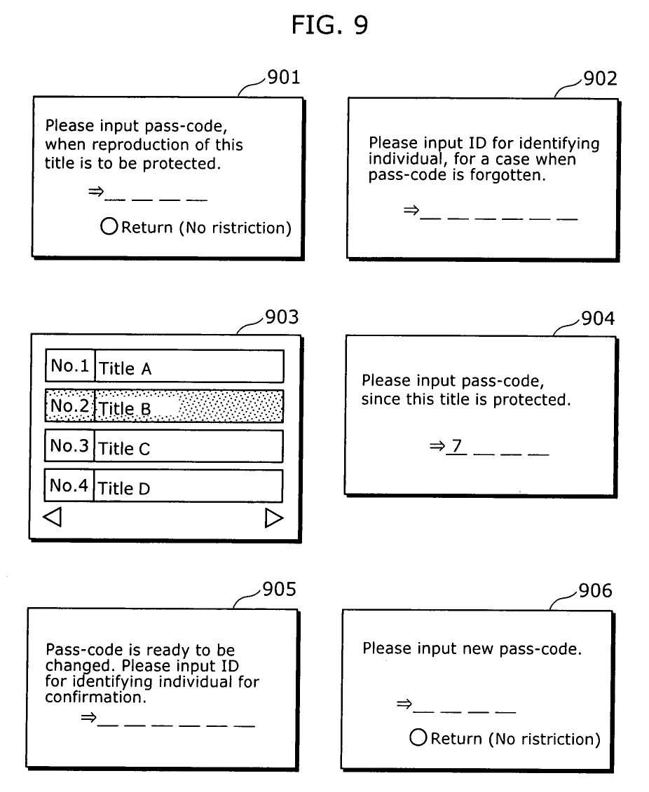

FIGS. 8 and 9 are diagrams for explaining a user interface according to the first embodiment of the present invention. As a practical example, the present invention is described to be used as a recorder.

As shown in FIG. 8, the data recording/reproducing device 801 is a recorder. Here, the data recording/reproducing device 801 is equivalent to the data recording/reproducing device 100 in FIG. 1. Video data is outputted from the data recording/reproducing device 801 via a video/audio cable 802 to an external monitor 803. A user uses a remote controller to control the data recording/reproducing device 801. Here, various messages as shown in FIG. 9 are displayed on the external monitor 803.

When the user presses a “recording” button of the remote controller, the data recording/reproducing device 801 becomes ready for recording target content data. When the recording is ready, the data recording/reproducing device 801 displays a message 901 on the monitor 803 in order to inquire the user whether or not the content data needs to be privately protected. If the private protection is necessary, the user is required to input a pass-code. Here, if the user does not input a pass-code but presses a “return” button of the remote controller, the data recording/reproducing device 801 records the content data without the private protection. On the other hand, if the user inputs a pass-code to execute the private protection, then the data recording/reproducing device 801 displays a message 902 on the monitor 803 in order to inquire the user to input an ID for identifying the user. This inputted ID is used in case the user will forget the pass-code set to protect the content data privately, so that a new pass-code can be replaced to the pass-code using the individual information held in the data recording/reproducing device 801.

In other words, if the content data is to be privately protected not to be reproduced by anyone except the user, the data recording/reproducing device 100 inquires the user to set a code, thereby obtaining a pass-code.

Note that the ID inputted according to the message 902 may be a name of the user for identifying the user.

Note also that the pass-code or the ID for identifying the individual user may be inputted as a parameter of recording reservation.

When the content data is to be reproduced, the user selects a title of the content data which the user wishes to reproduce. For example, if titles of content data recorded in the storage medium are displayed as shown in the message 903, then the user selects a target title and presses a “decision” button. If the title, which is selected when the user presses the “decision” button of the remote controller, is privately protected, the data recording/reproducing device 801 displays a message 904 on the monitor 803 in order to require the user to input a pass-code necessary to reproduce the content data.

In other words, when the privately protected content data is to be reproduced, the data recording/reproducing device 100 inquires the user to set a code, thereby obtaining a pass-code.

Note that when titles, whose content data are not privately protected, are firstly reproduced continuously, if a title whose content data is privately protected is found, the data recording/reproducing device 801 stops the recording and displays the message 904 to request the user to input the pass-code.

Note also that when the plural content data are continuously reproduced, if there is a title whose content data is protected using a different pass-code, the data recording/reproducing device 801 also requests the user to input a pass-code.

If the user forgets the correct pass-code which has been set in the recording of the content data, the content data cannot be reproduced, so that it is necessary to change the pass-code to a new pass-code. In this case, if the pass-codes can be easily changed, the aim of protection is lost. Therefore, in order to change the pass-code, the data recording/reproducing device 801 displays the message 905 to inquire the user to input the individual ID for identifying the user. If it is determined, based on the inputted individual ID, that the user is the user who has recorded the content data, the data recording/reproducing device 801 displays a message 906 to request the user to input a new pass-code.

Note that the individual ID inputted according to the messages 902 and 905 are identification information for identifying an individual. Depending on devices, the individual ID may be identification of a fingerprint for identifying an individual.

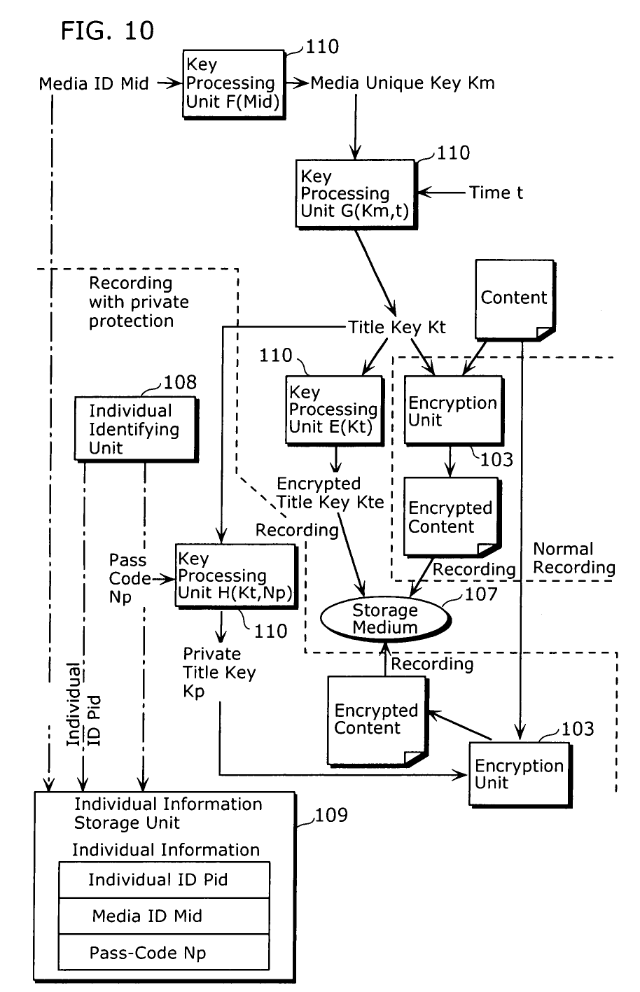

As described above, as shown in FIG. 10, regarding the data recording/reproducing device 100 according to the first embodiment of the present invention, when (a) content data is to be recorded, (a1) a medium unique key Km is generated using a medium ID assigned to a storage medium in which the content data is recorded, (a2) a title key Kt is generated using the medium unique key Km and a time t, (a3) a private title key Kp (encryption key) is generated using a pass-code Np and the title key Kt, (a4) an encrypted title key Kte (seed key) is generated by encrypting the title key Kt, (a5) encrypted content data is generated by encrypting the content data using the private title key Kp (encryption key), and (a6) the encrypted title key Kte (seed key) is associated with the encrypted content data to be written into the storage medium. Then, when (b) the content data is to be reproduced, (b1) the encrypted content data and the encrypted title key Kte (seed key) are read out from the storage medium, (b2) the title key Kt is obtained by decrypting the encrypted title key Kte (seed key), (b3) the private title key Kp (decryption key) is generated using the title key Kt and the pass-code Np, and (b4) the content data is obtained by decrypting the encrypted content data using the private title key Kp (decryption key).

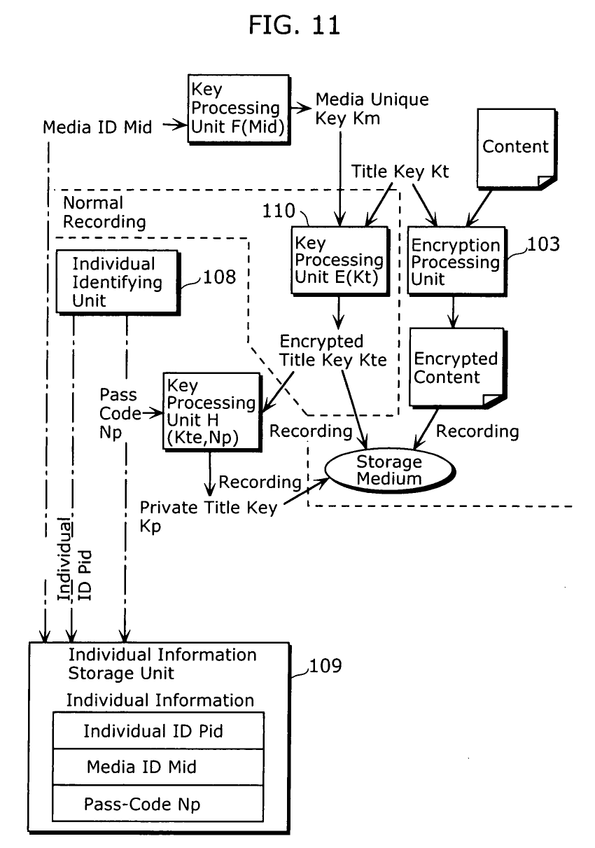

Note that in addition to the above, it is also possible that, as shown in FIG. 11, regarding the data recording/reproducing device 100 according to the first embodiment of the present invention, when (c) content data is to be recorded, (c1) a medium unique key Km is generated using a medium ID assigned to a storage medium in which the content data is recorded, (c2) encrypted content data is generated by encrypting the content data using a title key Kt (encryption key), (c3) an encrypted title key Kte is generated using the medium unique key Km and the title key Kt, (c4) a private title key Kp (seed key) is generated using a pass-code Np and the encrypted title key Kte, and (c5) the private title key Kp (seed key) is associated with the encrypted content data to be written into the storage medium. Then, when (d) the content data is to be reproduced, (d1) the encrypted content data and the private title key Kp (seed key) are read out from the storage medium, (d2) the encrypted title key Kte is obtained using the pass-code Np and the private title key Kp (seed key), (d3) the title key Kt (decryption key) is obtained using the medium unique key Km and the encrypted title key Kte, and (d4) the content data is obtained by decrypting the encrypted content data using the title key Kt (decryption key).

Thereby, the data recording/reproducing device 100 according to the first embodiment of the present invention can easily protect content data privately, using the conventional unauthorized copy prevention functions. Further, the pass-code which has been used to protect the content data privately is not recorded in the storage medium, so that the encrypted content data cannot be decrypted by analyzing the storage medium. Furthermore, even if the user has forgotten information regarding the pass-code necessary to generate the private title key, it is possible to re-protect the content data using a new pass-code.

### Second Embodiment

The following describes the second embodiment according to the prevent invention with reference to the drawings.

A data recording/reproducing device according to the second embodiment of the present invention obtains, as a pass-code, a code which is generated as a random number. In the random number code generating, identification information allocated to an ID card is used as a random number seed. The identification information of an ID card is obtained by referring to the IC card issued to the user. Based on the above, the following describes the data recording/reproducing device according to the second embodiment of the present invention.

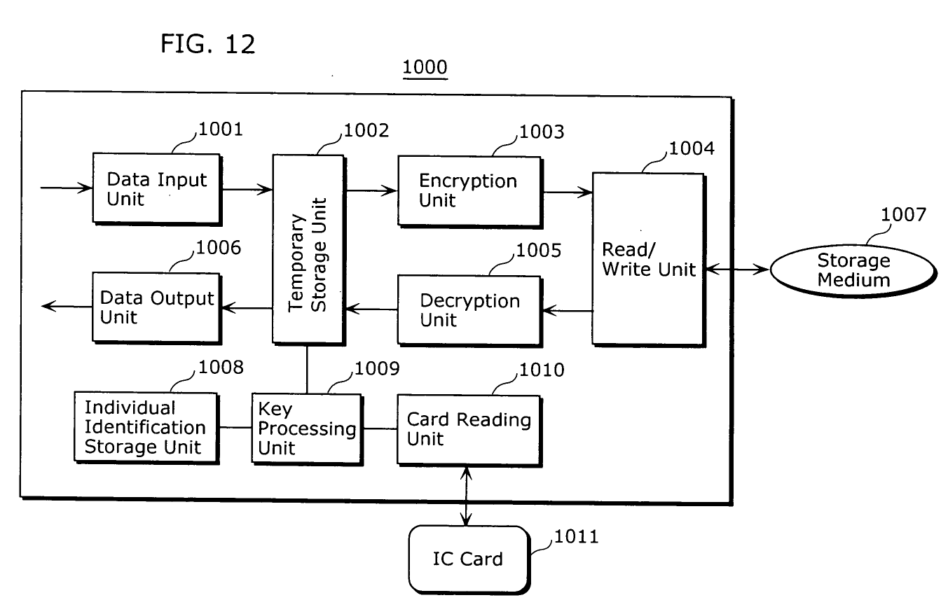

Firstly, FIG. 12 is a block diagram of the data recording/reproducing device according to the second embodiment of the present invention. The data recording/reproducing device 1000 includes: a data input unit 1001, a temporary storage unit 1002, an encryption unit 1003, a read/write unit 1004, a decryption unit 1005, a data output unit 1006, a storage medium 1007, an individual information storage unit 1008, a key processing unit 1009, a card reading unit 1010, and an IC card 1011. Note that recording and reproducing processing are performed by the above units basically in the same manner as described in the first embodiment.

In the second embodiment, the pass-code is automatically generated to privately protect content data not to be reproduced by anyone except the user. The IC card 1011 holds card identification information by which a specific subscriber is identified. One example of the IC card is a card used for digital broadcasting, such as a BS-Conditional Access System Card (B-CAS card, introduced by BS Conditional Access Systems Co., Ltd., Japan). More specifically, in the field of the digital broadcasting, a system is being constructed so that only a subscriber who is registered and subscribes to a broadcaster can view broadcasting data distributed by the broadcaster, using card identification information stored in the B-CAS card.

In order to record the broadcasting data, the card reading unit 1010 obtains the card identification information stored in the IC card 1011, and then a key processing unit 1009 generates a pass-code using the obtained card identification information. Using the generated pass-code, the encryption and decryption processing as described above can be realized. Further, in case of a loss of the IC card 1011, the card identification information is stored in the individual information storage unit 1008 which is a nonvolatile memory such as a EEPROM. An example of a data format of the individual information is as shown in FIG. 7. That is, the individual information includes: the individual ID 702 that is the card identification information; the medium ID 703 for identifying a storage medium; and a pass-code 704 generated from the card identification information. If the IC card 1011 is lost, a new pass-code is generated using card identification information of a re-issued IC card, and then the pass-code of the old card identification information is replaced to the new pass-code.

In the second embodiment, a title key used to encrypt and decrypt content data is generated using a pass-code which is generated from the card identification information allocated to each subscribing user. Then, a system is provided so that, if the user records the content data using the IC card, the content data cannot be reproduced without the IC card. This causes an effect of preventing the recorded content data from being reproduced by anyone who does not have the ID card issued to the subscriber.

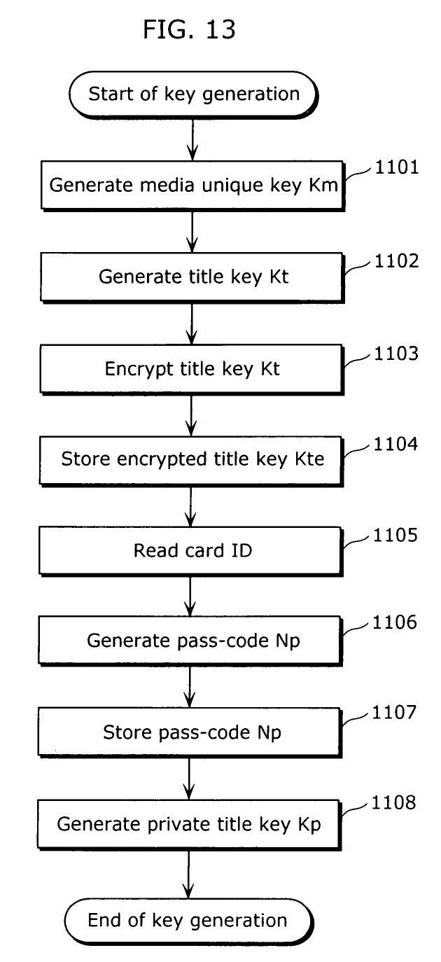

FIG. 13 is a flowchart showing title key generating processing according to the second embodiment of the present invention.

The data recording/reproducing device 1000 generates a medium unique key Km (Km=F(Mid)), using a medium ID 703 which is information unique to a specific storage medium 1007 and read out from the storage medium 1007 (Step 1101). Here, Mid is a medium ID represented by a serial number. Next, the medium unique key Km is added with a time varying factor to generate a title key Kt (Kt=G(Km, t)) (Step 1102). The title key Kt is important information for decrypting content data to be recorded. In order to prevent tampering of the generated title key Kt to be recorded into the storage medium 107, the data recording/reproducing device 1000 encrypts the generated title key Kt (Step 1103). Then, the encrypted title key Kte (Kte=E(Kt)) is recorded into the storage medium 107 (Step 1104). In general, the content data is encrypted by the title key Kt. However, if the content data is to be protected privately using the card identification information, the content data is to be encrypted by a private title key Kp. In order to generate the private title key Kp, firstly card identification information Cid is read out from an IC card (Step 1105). Then, using a random number S, a pass-code Np (Np=Z(Cid, S)) necessary to generate the private title key Kp is generated (Step 1106). Then, as the individual information 701, into the individual information storage unit 1108 stored are: card individual identification (individual ID 702) for identifying the user who has generated the pass-code; the medium ID 703 for identifying the storage medium 107; and the generated pass-code Np704 (Step 1107). A private title key Kp (Kp=H(Kt, Np)) for the private protection is generated (Step 1108).

As described above, the data recording/reproducing device 1000 according to the second embodiment of the present invention generates the private title key every time content data is reproduced, instead of previously recording, into the storage medium, the private title key associated with the content data. Here, the private title key is generated using the card identification information stored in the IC card. Thereby, only the user which inserts the IC card into the data recording/reproducing device can decrypt the encrypted content data.

### Third Embodiment

The following describes the third embodiment according to the prevent invention with reference to the drawings.

By the data recording/reproducing device according to the third embodiment of the present invention, (a1) when a data management device manages: individual identification information for identifying respective users; and pass-codes associated with the respective individual identification information, (a2) individual identification information for identifying a certain user is obtained, (a3) the obtained individual identification information is sent via a data communication network to the data management device, and (a4) a pass-code associated with the sent individual identification information is received from the data management device.

The data management device (server system) is also described herein below. The management device is connected with the data recording/reproducing device (client system) via a data communication network (network). Note that a system having the data recording/reproducing device (client system) and the data management device (server system) is herein called a data recording/reproducing system.

Here, the data management device (b1) manages a pass-code corresponding to each user, (b2) holds individual identification information for identifying the user, which is associated with the pass-code, (b3) receives the individual identification information sent from the data recording/reproducing device which records and reproduces content data, (b4) specifies the pass-code associated with the received individual identification information, among one or more pass-codes held in the data management device, and (b5) sends the specified pass-code to the data recording/reproducing device.

Based on the above, the data recording/reproducing device according to the third embodiment of the present invention is described.

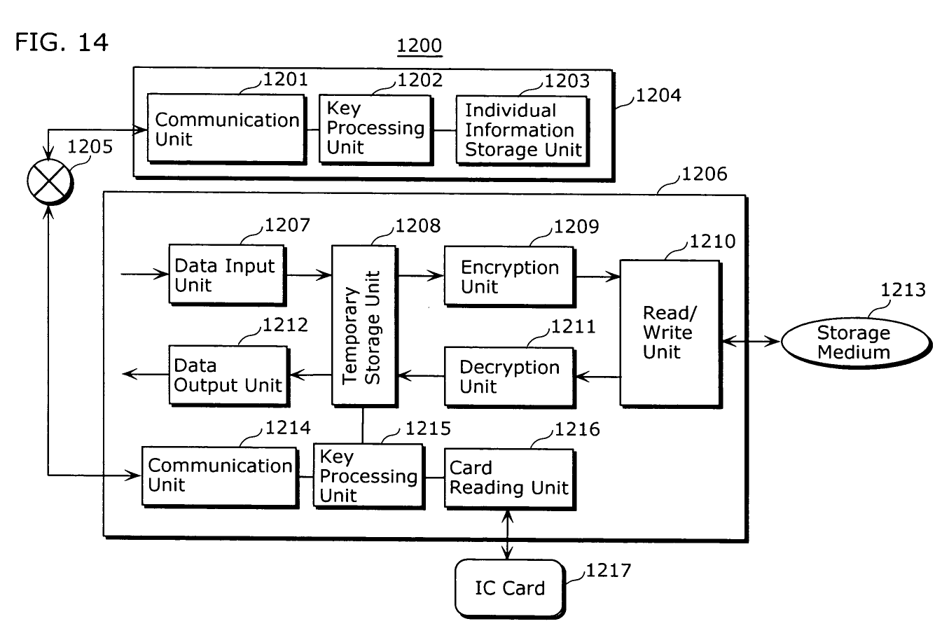

Firstly, FIG. 14 shows a structure of the data recording/reproducing system in which a pass-code is generated by a system for providing broadcasting content data, not by a system for recording the broadcasting content data. The data recording/reproducing system 1200 has a server system 1204 and a client system 1206. The server system 1204 provides content data to the client system 1206. The client system 1206 encrypts the content data to be recorded, and also decrypts the content data to be reproduced. The server system 1204 and the client system 1206 are connected with each other via the Internet 1205.

The server system 1204 has a communication unit 1201, a key processing unit 1202, and an individual information storage unit 1203.

The client system 1206 has a data input unit 1207, a temporary storage unit 1208, an encryption unit 1209, a read/write unit 1210, a decryption unit 1211, a data output unit 1212, a storage medium 1213, a communication unit 1214, a key processing unit 1215, a card reading unit 1216, and an IC card 1217.

The communication unit 1201 is connected with the client system 1206 via the Internet 1205. The communication unit 1201 searches the individual information storage unit 1203 for individual information associated with card identification information of a subscribing user obtained by the communication unit 1201, thereby identifying the subscribing user. Here, if the user is a new subscriber, in the server system 1204, the key processing unit 1202 generates a pass-code, and the individual information storage unit 1203 stores the generated pass-code.

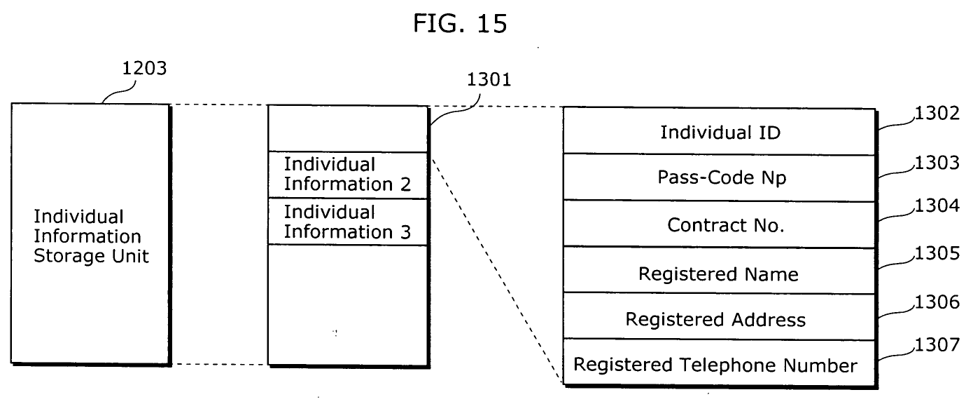

FIG. 15 is a diagram showing an example of a data format of information stored in the individual information storage unit 1203. As shown in FIG. 15, the individual information 1301 is stored on a subscriber-by-subscriber basis. The individual information 1301 includes: an individual ID 1302 for identifying a subscriber; a pass-code Np 1303 which the subscriber uses; a subscriber number 1304: a registered name 1305 of the subscriber; a registered address 1306 of the subscriber at the time of registration; and a registered telephone number 1307 of the subscriber. Moreover, by using a pass-code which only a user subscribing to a broadcaster can obtain, it is possible to prevent broadcasting contents from being reproduced by non-subscribers who do not pay for the content data.

The card identification information, which the card reading unit 1216 has read out from the IC card 1217, is transferred via the communication unit 1214 and the Internet 1205 to the server system 1204. Then, the client system 1206 receives a pass-code associated with the card identification information, from the server system 1204. The received pass-code is necessary to generate a title key used to encrypt and record the broadcast content data. The received pass-code is not stored in the storage medium 1213 nor the client system 1206, so that when the content is to be reproduced, it is necessary to receive the pass-code from the server system 1204 via the communication unit 1214 and the Internet 1205.

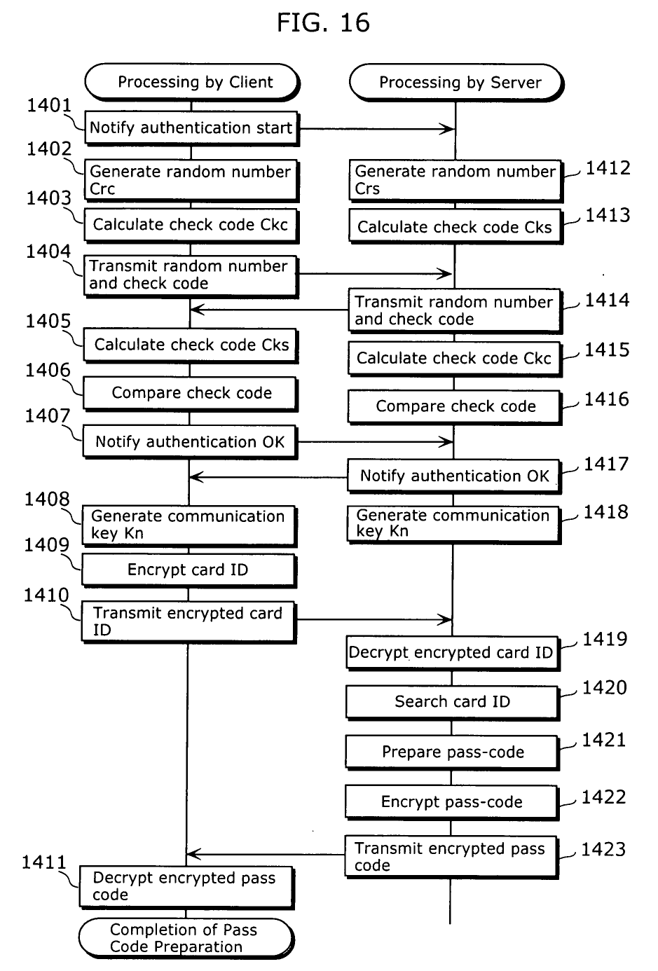

FIG. 16 is a diagram for explaining processing by which the client system 1206 receives a pass-code from the server system 1204.

The client system 1206 starts processing for obtaining the pass-code, when the client system 1206 starts after power-on. In order to safely transfer the card identification information Cid, the pass-code Np, and the like, between the client system 1206 and the server system 1204, authentication processing is necessary between the client system 1206 and the server system 1204. Firstly, the client system 1206 notifies start of the authentication to the server system 1204 (Step 1401). The client system 1206 generates a random number Crc (Step 1402), and calculates a check code Ckc (Ckc=M(Crc)) from the random number Crc (Step 1403). The random number Crc and the calculated check code Ckc are transferred to the server system 1204 (Step 1404). The server system 1204 is notified of the start of the authentication by the client system 1206, then generates a random number Crs (Step 1412), and calculates a check code Cks (Cks=N(Crs)) from the random number Crs (Step 1413). The random number Crs and the calculated check code Cks are transferred to the client system 1206 (Step 1414). The client system 1206 calculates a check code Cks using the random number Crs sent from the sever system 1204 (Step 1405), then compares the check code Cks calculated by the client system 1206 with the check code Cks calculated by the server system 1204 (Step 1406). If the both check codes Cks are identical, it is determined that the authentication between the systems is verified, and then client system 1206 notifies the server system 1204 of the verification (Step 1407). On the other hand, the server system 1204 also calculates a check code Ckc using the random number Crc sent from the client system 1206 (Step 1415), then compares the check code Ckc calculated by the server system 1204 with the check code Ckc calculated by the client system 1206 (Step 1416). If the both check codes Ckc are identical, it is determined that the authentication between the systems is verified, and then the server system 1204 notifies the client system 1206 of the verification (Step 1417). When the authentication is verified, both of the client system 1206 and the server system 1204 generate respective communication keys Kn (Kn=k(Crc, Crs)) used to safely transfer data between the systems (Steps 1408 and 1418). Using the above communication key Kn, the client system 1206 encrypts the card identification information Cid which the card reading unit 1216 obtains from the IC card 1217 (Step 1409). The encrypted card identification information Ceid (Ceid=E(Kn, Cid)) is transmitted to the server system 1204 (Step 1410). The server system 1204 receives the encrypted card identification information Ceid, and then decrypts the encrypted card identification information Ceid using the communication key Kn to obtain the card identification information Cid (Cid=D(Kn, Ceid)) (Step 1419). Using the received card identification information Cid, the server system 1204 searches for a subscriber in the individual information storage unit 1203, thereby identifying the subscriber (Step 1420). If there is the pass-code in the individual information storage unit 1203, then the pass-code is obtained. If such a pass-code is not found, then a pass-code Np (Np=Z(Cid, S)) is newly generated. The newly generated pass-code Np is stored into the individual information storage unit 1203. Thereby, the pass-code Np associated with the card identification information Cid is prepared (Step 1421). The pass-code Np is encrypted using the above communication key Kn (Step 1422). The encrypted pass-code Nep (Nep=E(Kn, Np)) is transmitted to the client system 1206 (Step 1423). The client system 1206 receives the encrypted pass-code Nep, and then decrypts the encrypted pass-code Nep by the communication key Kn to obtain a pass-code Np (Np=D(Kn, Nep)) (Step 1411). The client system 1206 performs recording and reproducing using the pass-code Np obtained in the above processing. The recording and the reproducing are as described in the above embodiments.

As described above, the pass-code used for encryption and decryption are generated and managed by the server system 1204, not by the client system 1206 which actually records and reproduces content data. This enables the server system 1204 to control and permit the client system 1206 to reproduce the recorded content data.

This means that, if a certain subscriber records a useful content data created by a broadcasting station, anyone can reproduce and view the recorded content data. According to the third embodiment, however, such recorded content data cannot be viewed without an IC card (B-CAS card for digital broadcasting, for example) which is possessed by a subscriber who has recorded the content data. Therefore, it is possible to provide a broadcaster and a producer of the content data with a means for gaining an adequate profit from the content data.

Note that the data recording/reproducing device according to the present invention may have a Central Processing Unit (CPU), a Large Scale Integration (LSI) system, a Random Access Memory (RAM), a Read Only Memory (ROM), a Hard Disk Drive (HDD), a tuner, an input/output interface, a network interface, and the like. Further, the data recording/reproducing device may have a drive by which data can be read out from and written into a portable storage medium, such as a DVD-RAM and a Secure Digital (SD) memory card. Furthermore, the data recording/reproducing device may have a card reader which can read data from an IC card and the like.

Note also that it is also possible that an Operating System (OS) and the data recording/reproducing program executed by the OS are installed in a HDD or a ROM, and by executing the data recording/reproducing program, each of the functional units is realized. Further, the units can be accessed by the CPU. Furthermore, data inputted by an input device such as a remote controller may be sent to the units via the input/output interface, or data processed by the units may be outputted to an output device such as a monitor via the input/output interface.

Note also that the present invention may be realized as a program for causing a computer to execute a part or all of the units of the above-described data recording/reproducing device, and a part or all of the processing of the data recording/reproducing method.

Note also that the present invention may be a realized as a storage medium in which the above program is stored. Here, the program, which can be or have been read out by the computer, is used in cooperation with the computer.

Note also that the present invention may be realized as: a data recording device having units related to the recording functions of the data recording/reproducing device; a data recording method performed by the data recording device; a data recording program for causing a computer system or the like to execute the data recording method; or a storage medium in which the data recording program is stored.

Note also that the present invention may be realized as: a data reproducing device having the units related to the reproducing functions of the data recording/reproducing device; a data reproducing method performed by the data reproducing device; a data reproducing program for causing a computer system or the like to execute the data reproducing method; or a storage medium in which the data reproducing program is stored.

### INDUSTRIAL APPLICABILITY

The data recording/reproducing device according to the present invention is useful as a data recording/reproducing device by which a user can privately protect and record content data not to be reproduced by anyone except the user, and by which the user can reproduce the privately protected and recorded content data.

1-18. (canceled)

19. A data recording/reproducing system comprising: a data recording/reproducing device which records and reproduces content data; and a data management device which is connected to said data recording/reproducing device via a data communication network,
wherein said data management device includes:
a storage unit, in which a pass-code corresponding to a specific user and individual identification information for identifying the specific user are stored in associated with each other;
a first receiving unit operable to receive individual identification information for identifying a user of said data recording/reproducing device;
a specifying unit operable to specify a pass-code associated with the individual identification information received by said first receiving unit, from one or more pass-codes stored in said storage unit; and
a first sending unit operable to send the pass-code specified by said specifying unit to said data recording/reproducing device, when the user of said data recording/reproducing device is the specific user, and
said data recording/reproducing device includes:
an individual identification information obtaining unit operable to obtain the individual identification information for identifying a user of said data recording/reproducing device;
a second sending unit operable to send the individual identification information obtained by said individual identification information obtaining unit to said data management device;
a second receiving unit operable to receive, from said data management device, a pass-code associated with the individual identification information sent from said second sending unit, when the user of said data recording/reproducing device is the specific user;
a recording unit operable to record a predetermined content data using the pass-code received by said second receiving unit, when content data is recorded into a storage medium and the user of said data recording/reproducing device privately protects and records the predetermined content data; and
a reproducing unit operable to reproduce the predetermined content data using the pass-code received by said second receiving unit, when among the content data recorded by said recording unit into the storage medium, the predetermined content data which is privately protected and recorded is reproduced.

20. The data recording/reproducing system according to claim 19,
wherein said recording unit is operable to record, as the content data, a program broadcasted via a digital broadcast wave.

21. The data recording/reproducing system according to claim 19,
wherein, in said storage unit, (i) individual identification information for identifying a subscriber who subscribes to a broadcaster, as the individual identification information for identifying the specific user; and (ii), a pass-code corresponding to the subscriber, as the pass-code corresponding to the specific user are stored.

22. A data recording/reproducing device which records and reproduces content data, said data recording/reproducing device comprising:
an individual identification information obtaining unit operable to obtain individual identification information for identifying a user of said data recording/reproducing device;
a sending unit operable to send the individual identification information obtained by said individual identification information obtaining unit to a data management device which manages a pass-code corresponding to a specific user and individual identification information for identifying the specific user in association with each other;
a receiving unit operable to receive, from the data management device, the pass-code associated with the individual identification information sent from said sending unit, when the user of said data recording/reproducing device is the specific user;
a recording unit operable to record a predetermined content data using the pass-code received by said receiving unit, when content data is recorded into a storage medium and the user of said data recording/reproducing device privately protects and records the predetermined content data; and
a reproducing unit operable to reproduce the predetermined content data using the pass-code received by said receiving unit, when among the content data recorded by said recording unit into the storage medium, the predetermined content data which is privately protected and recorded is reproduced.

23. A data management device which is connected via a data communication network to a data recording/reproducing device that records and reproduces content data, said data management device comprising:
a storage unit, in which a pass-code corresponding to a specific user and individual identification information for identifying the specific user are stored in association with each other;
a receiving unit operable to receive individual identification information for identifying a user of said data recording/reproducing device;
a specifying unit operable to specify a pass-code associated with the individual identification information received by said receiving unit, from one or more pass-codes stored in said storage unit; and
a sending unit operable to send the pass-code specified by said specifying unit to said data recording/reproducing device, when the user of said data recording/reproducing device is the specific user.
